(19) United States
(12) Patent Application Publication
(10) Pub. No.: US 2010/0025063 A1
(43) Pub. Date: Feb. 4, 2010

(54) Impact wrench having a pin clutch impact mechanism and being torque limited

(76) Inventors: Frank Kuhnapfel, Mulheim a.d. Ruhr (DE); Magnus Ahles, Mulheim a.d. Ruhr (DE)

Correspondence Address: JAMES C. WRAY, 1493 CHAIN BRIDGE ROAD, SUITE 300, MCLEAN, VA, 22101, US

(21) Appl. No.: 12/311,794

(22) PCT Filed: Oct. 2, 2007
(86) PCT No.: PCT/DE2007/001769

§ 371 Date: Apr. 30, 2009

(30) Foreign Application Priority Data
Oct. 13, 2006 (DE) 10 2006 048 563.7

(51) Int. Cl. B25B 21/02

(52) U.S. Cl. 173/203

(57) ABSTRACT

An impact wrench 1, with a motor for transmitting a rotary movement to a spindle 2 located in a hammer cage 11 and with a cam drive 9, on the end face 12 of which a track 13 with an elevation 14 is located, is used to transmit frictional movement to the bolts to be tightened. In conjunction with the hammer cage 11, the cam drive 9 forms a channel 15 for the rotation of a ball 16 and engages in axially-displaceable pins 6, 7, which compress a spring 17 ensuring a return to the starting position by a displacement movement on a collar 3 surrounding the spindle 2 and triggering the hammer mechanism. A link 8 is provided between the pins 6, 7 and the collar 3 to transmit principally frictional movement between the pins 6, 7 and the spindle 2.

The invention concerns an impact wrench with a motor for transmission of a rotary movement to a spindle located in a hammer cage and with a cam drive, on the end face of which a track with an elevation is located, whereby the cam drive in conjunction with the hammer cage forms a channel for a ball to circulate in a ball race and whereby the cam drive engages in axially displaceable pins, which compress a spring ensuring a return to the original position by displacement acting on a collar surrounding the spindle and triggering the hammer mechanism.

Such impact wrenches are used to tighten and release bolted connections. For example, they are indispensable to businesses involved in changing wheels on motor vehicles. The devices are pneumatically or electrically powered and are suitable for applying rotary and impact forces to the bolts, in order to be able to apply the impact forces necessary to release bolts, if unequally high forces need to be applied due to dirt, ageing and operating loads on the vehicle, particularly if attributable to high brake temperatures. Various proposals for regulating or restricting the torque when tightening the bolts exist. For example, such a device is known from DE 198 33 943. It is intended to prevent over-tightening of the bolts due to excessive torque, so that they bite into the countersink or seat of a hub. This may lead to destruction of the bolted connection and the contact surfaces, particularly the thread. The accompanying damage is considerable, in terms of both safety and cost. The above solution has proved disadvantageous in that this method was dependent on external influences such as soiling of the bolted connection, the skill of the user or the compressed air supply.

This invention thus sets itself the problem of providing a better proposal for an impact wrench which precludes over-tightening of the bolts and thus the associated damage.

This problem is solved by the provision of a link to transmit frictional movement between the pins and the spindle.

The cam drive or pins make the spindle rotate only in the direction of rotation in impact movements which correspond to releasing the bolt, i.e. when the additional impact mechanism is required. Conversely, in the case of rotation in the other direction, to tighten the bolt, frictional movement is transmitted between the cam drive or pins and spindle, which restricts the torque applied. Specifically, this link is located in the vicinity of the pins or spindle so that mainly frictional force is transmitted to the spindle by the pins.

A link for transmitting slight impact and subsequently frictional movement between the pins and the spindle is also provided between the pins and the collar. Within the scope of this preferred version, a slight impact movement which gives way to or snaps into frictional movement with corresponding rotation occurs.

A preferred embodiment provides for the link to be at the collar end. The overriding concern is that the thickness of the collar is not constant. This means that the spindle is placed only in rotation in one direction instead of in impact movement under a corresponding load from the pins, because the form of the collar means that only reduced force can be exercised on the spindle cams. This entails an advantageous restriction of torque in relation to a direction of rotation corresponding to tightening the bolts, whilst the full impact force can be applied in the other direction of rotation, as hitherto.

Such an embodiment is, for example, achieved, if the collar has diagonally-extending sections, so that the thickness of the collar surrounding the spindle diminishes in specific stages. Reduced forces are thus exercised on the diagonally-extending sections of the collar when the pins are displaced longitudinally, triggered by the movement of the cam drive. To some extent, the angle of these diagonal sections specifies the frictional force, while a shoulder on the end face of the cam-like projection serves as an impact surface, if a preceding slight impact movement is to be achieved.

In principle, the collar has four sections, namely two round areas of reduced width and two cam-like projections of greater width. It is intended that the sections be allocated to the two projections on the collar end. The diagonally-extending sections are thus located on the projections at the collar end. The embodiment of the collar described above is accompanied by the projections being at 180° to each other. They are thus located on opposite sides of the spindle.

It is considered particularly expedient for the projections to have a cam track. The form and location of this three-dimensional cam track are matched to the torque to be applied when tightening the bolts. This cam track is simultaneously dimensioned so that friction can be transmitted by the track without affecting the bolting behaviour and without harming the material when the spindle rotates in the other direction.

This is the case, for example, if the cam track has a concave or convex form. An alternative proposal for such a cam track provides for the projections having a straight surface on which the frictional forces are transmitted between the pins and the spindle.

To achieve the desired effect when tightening the bolt, the arrangement of diagonally-extending sections is matched to the clockwise rotation of the impact wrench. This direction corresponds to tightening a normal right-hand thread. In the other, anti-clockwise, direction, the material of the collar is left alone, to develop the full impact effect.

The invention is particularly distinguished by the creation of an impact wrench with a pin clutch hammer with torque restriction, in which transmission of primarily frictional movement between the pins and the spindle takes place advantageously in a direction of rotation which corresponds to tightening the means of fastening, whilst the full impact effect of the pins on the spindle can be developed in the opposite direction of rotation. Conversely, an impact movement before the frictional movement is avoided if it is neither desired nor necessary, with the exception of a preferred embodiment with a comparatively light impact. For this purpose, the spindle has a collar with two cam-like projections on opposite sides of the spindle, the thickness of which collar is not constant. Specifically, diagonal, track-like or straight sections, along which the pins rub, are located here. A conceivably simple. reliable technical solution is thus achieved, which is independent of the comparatively structurally complicated and thus vulnerable mechanical system associated with the cam drive and the cam track between the latter and the hammer cage.

Further details and advantages of the invention emerge from the following description of the relevant drawing, which shows a preferred specimen embodiment with the necessary details and individual parts.

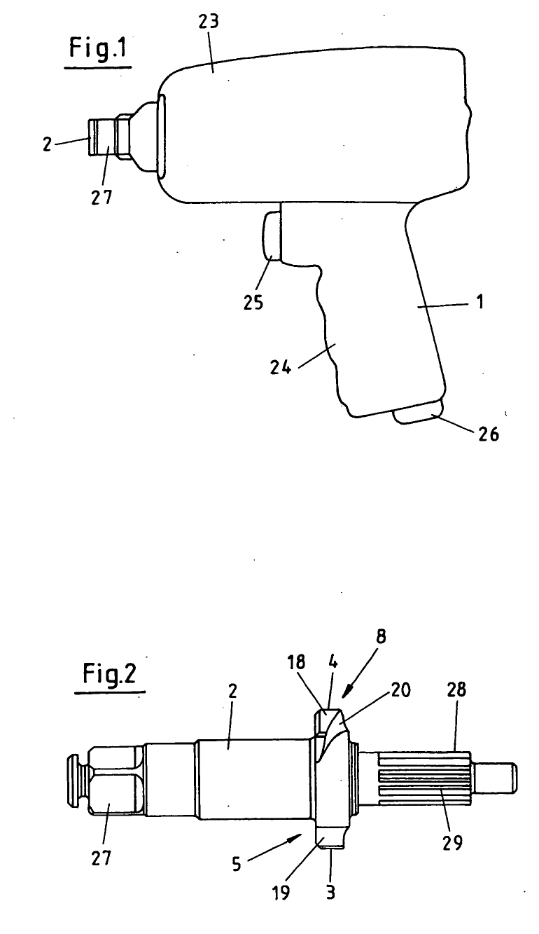

FIG. 1 shows an impact wrench

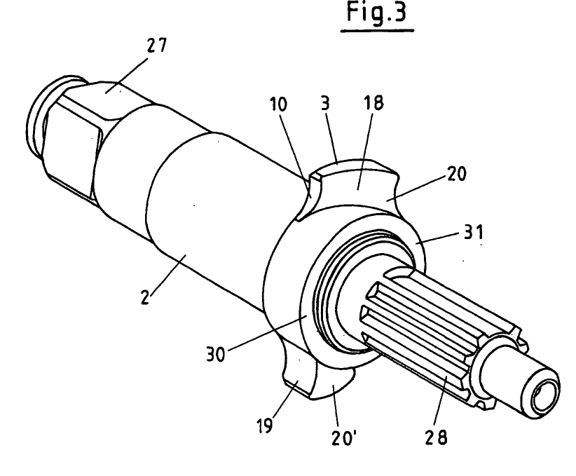

FIG. 2 a side elevation of a spindle

FIG. 3 a three-quarter view of a spindle and

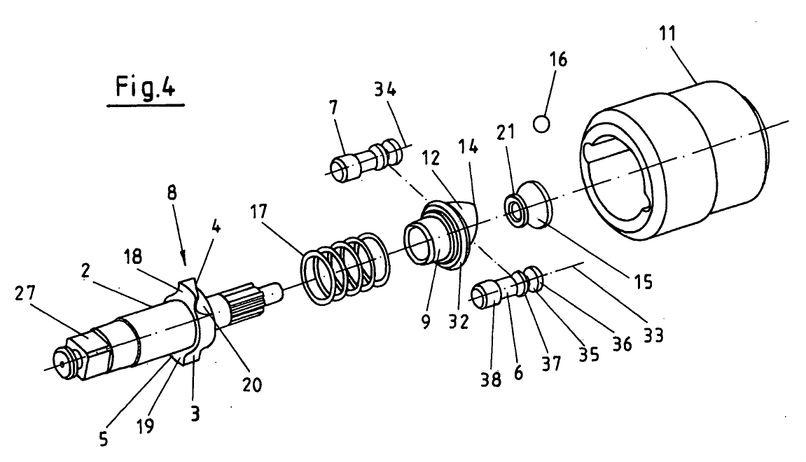

FIG. 4 an exploded view of the relevant components.

FIG. 1 shows an impact wrench 1 with the housing 23 and handle 24. The button 25 for operating the impact wrench 1 and the compressed air connection 26 can also be recognised. Torque is exercised on the fastenings, e.g. bolts, by the spindle 2 and the socket 27, whereby different forces may be applied in the direction for releasing and tightening the fastenings by the inventive impact wrench 1, by which, in particular, torque may be limited so that predominantly friction may be transmitted between the pins not shown here and the spindle 2.

The latter is shown in FIG. 2. The collar 3 may be discerned, approximately in the middle of the spindle 2, as well as the socket 27 and the surface 28 with indentations 29 in the form of a spline, surrounded by the pressure spring in operation and matching the cam drive 9. The collar 3 includes two sections 4 and 5 on opposite sides of the collar 3, at 180° to each other, whereby the cam track 20 may be recognised on section 4. It forms part of the cam-like projection 18, similar to the section 5 not shown here of the opposite projection 19. Sections 4, 5 form a link 8 for the striker pins not shown here, by the latter rubbing along the cam track 20, by which only reduced, and particularly no impact, forces can be applied to the spindle 2 when tightening bolts.

FIG. 3 is a three-quarter view of the same spindle, where the collar 3 is particularly easy to recognise. It is formed by two projections 18, 19, the collar section 30 and the opposite collar section 31. Whilst the collar sections 30, 31 are round, the cam-like projections 18, 19 are significantly wider. The cam track 20 on the projection 18, the thickness of which is considerably reduced in relation to the collar sections 30, 31. The shoulder on the projection 18 serving as an impact surface is designated 10, which the striker pins initially strike lightly, before transition or snapping into frictional movement takes place.

FIG. 4 shows the components which are particularly relevant to the invention. Apart from the spindle 2, these are the compression spring 17, the two pins 6 and 7, the cam drive 9, the ball race 21 and the hammer cage 11. A track 13 with an elevation 14 is located on the end face 12 of the cam drive 9. A channel 15 for rotation of the ball 16 is located between the end face 12 of the cam drive 9 and the ball race 21 integrated into the hammer cage 11. When the cam drive 9 rotates, the formation of the elevation 14 and the ball 16 in the channel 15 displace the cam drive 9 longitudinally. The cam drive 9 has a collar 32 which engages in the gap 35 between the two collars 36, 37 on the pins 6, 7. In this way, the movement is transmitted to the pins 6, 7, which move in the direction of their longitudinal axes 33, 34 and thus exercise principally frictional force on the collar 3 on the spindle through the pin head 38 and thus on the spindle 2 when the spindle 2 rotates in the corresponding direction. The spring 17 then ensures a return to the starting position. Conversely, rotation in the other direction invokes the intended impact movements of the pin head 38 on the collar 3, which are required particularly to release bolts which have bitten into the material after long use.

1. An impact wrench (1) with a motor to transmit rotary movement to a spindle (2) arranged in a hammer cage (11) and with a cam drive (9), on the end face (12) of which a track (13) with an elevation (14) is located, by means of which the cam drive (9) in conjunction with the hammer cage (11) forms a channel (15) for the rotation of a ball (16) in a ball race (21) and where the cam drive (9) engages in axially-displaceable pins (6, 7), which compress a spring (17) ensuring the return to the starting position by a displacement movement on a collar (3) surrounding the spindle (2) and triggering the impact mechanism, wherein a link (8) is provided between the pins (6, 7) and the collar (3) to transmit frictional movement between the pins (6, 7) and the spindle (2).

2. The impact wrench of claim 1, wherein a link (8) for transmitting initially slight impact and subsequently frictional movement between the pins (6, 7) and the spindle (2) is also provided between the pins (6, 7) and the collar (3).

3. The impact wrench of claim 1, wherein the link (8) is provided on the collar side.

4. The impact wrench of claim 1, wherein the thickness of the collar (3) is not constant.

5. The impact wrench of claim 1, wherein the collar (3) has diagonally-extending sections (4, 5).

6. The impact wrench of claim 5, wherein the sections (4, 5) are allocated to the two projections (18, 19) on the collar side.

7. The impact wrench of claim 1, wherein the projections (18, 19) are at 180° to each other.

8. The impact wrench of claim 1, wherein the projections (18, 19) have a cam track (20).

9. The impact wrench of claim 1, wherein the cam track (18, 19) has a concave or convex form.

10. The impact wrench of claim 1, wherein the projections (18, 19) have a straight surface.

11. The impact wrench of claim 1, wherein the arrangement of the diagonally-extending sections (4, 5) is matched to the clockwise direction of rotation of the impact wrench.
